(19) United States
(12) Patent Application Publication
(10) Pub. No.: US 2026/0307947 A1
(43) Pub. Date: Oct. 8, 2026

(54) REMOTELY OPERABLE LIFTING EQUIPMENT

(71) Applicants: Caine Ian LUMSDEN, Hamilton (NZ); Ross James LUMSDEN, Hamilton (NZ)

(72) Inventors: Caine Ian LUMSDEN, Hamilton (NZ); Ross James LUMSDEN, Hamilton (NZ)

(21) Appl. No.: 19/482,357

(22) PCT Filed: May 13, 2024
(86) PCT No.: PCT/NZ2024/050053

§ 371 Date: Nov. 7, 2025

(30) Foreign Application Priority Data
May 12, 2023 (AU) 2023901443

(51) Int. Cl. B66C 1/36

(52) U.S. Cl. CPC B66C 1/36

(57) ABSTRACT

A load lifting clutch includes a body with a cavity connected to a side opening receiving a lifting point, located within the cavity is a first and second pivotable lever arrangement, including at least one first lever and at least one second lever, the pivotable lever arrangement provides: a closed position where the opening to the cavity is at least partially blocked by the second lever engaged with the first lever; and an open position wherein the second lever moves to provide free access to the cavity via the opening when the first lever disengages the second lever; the first or second lever is held in engagement with the respective first or second lever to maintain a closed position, via a magnet attached to the first or second lever to magnetically couple the first or second lever to the body, so the cavity maintains a laterally and upwardly inclined orientation.

### FIELD OF INVENTION

The invention relates to remotely operable lifting equipment, and in particular a remotely operable clutch mechanism for use with hook for lifting a load.

### BACKGROUND TO THE INVENTION

Lifting hooks for use with cranes or other machinery used for lifting loads are well known. Such hooks are used in a multitude of industries including construction and cargo handling. A typical hook has a hook member on which a lifting strop, sling, chain or other lifting/rigging equipment attached to a load to be lifted is placed. Once a lifting operation has been completed, an operator removes the strop or other lifting/rigging equipment from the hook member.

Clutches or coupling mechanisms for use with hooks assist with coupling a hook to a lifting point are also well known. A lifting point may not be adapted for direct lifting by a hook. Therefore, a clutch is used to engage the lifting point and provide an interface such as an eye or shackle that can be picked up and held by the hook on a crane or such like.

A remotely operable clutch can be limited in the maximum loading/weight the clutch can lift by the assembly's remotely operable release mechanism and/or strength of magnet used to magnetically couple the first lever to the body.

The remotely operable release mechanism must be robust enough to hold the clutch in the closed position, but equally an actuator or the release mechanism must have sufficient power to release and move the clutch to the open position and together with gravity overcome the force coupling the first lever to the body.

A remotely operable clutch may have many parts increasing manufacturing costs and maintenance requirements and introduce reliability issues. The applicant's previous clutch described in WO 2022/081024 utilised a compression spring and a ball bearing arrangement to hold (i.e. lock) the clutch in a closed position. The applicant has found however that over time the spring may be prone to rust and can lose compression strength additionally the ball bearing can become damaged and less effective as a locking means.

It would be useful if there could a provided a clutch which can reliably hold a closed position for a set a lifting capacity and can easily be adjusted to increase or decrease the lifting capacity as required.

It would be useful if there could be provided a clutch which can prevent rotation of a load relative to the clutch when the load is being moved forward by a lifting apparatus.

### OBJECT OF THE INVENTION

It is one object of the invention to provide a lifting apparatus comprising a remotely operable clutch for use as an interface for a hook that addresses the above-mentioned problems, or to at least provide the public with a useful choice.

Other objects achieved by the present invention may be apparent from the description of the present invention detailed in this specification.

### SUMMARY OF THE INVENTION

### Magnetic Coupling Aspect

According to a first aspect of the invention there is provided a clutch assembly for use with lifting equipment for lifting a load, the clutch comprising:
a body;
   wherein the body has a cavity connected to an opening on the side of the body to receive a lifting point therein, wherein located within said cavity is a first and second pivotable lever arrangement, comprising a first lever or pair of connected levers and a second lever or pair of connected levers, wherein the pivotable lever arrangement provides:
a closed position where the opening to the cavity is at least partially blocked by the second lever/second lever pair which is engaged with the first lever/first lever pair; and
an open position wherein the second lever/lever pair moves to provide free access to the cavity via the opening when the first lever/lever pair disengages the second lever/lever pair;
   wherein the first or second lever/lever pair is held in engagement with the respective first or second lever/lever pair to maintain a closed position, via a magnet attached to said first or second lever/lever pair to magnetically couple said first or second lever/lever pair to said body, so the cavity maintains a laterally and upwardly inclined orientation.

This first aspect of the present invention can be utilised with either a ball or bar type lifting point.

In a preferred embodiment to release magnetic engagement of the first lever to the body and thus engagement of the first lever with the second lever, includes a remotely operable cable and winch arrangement attached to one end of the first lever, that pulls the first lever upwardly and rotates the first lever, which together with the weight of a load secured in said cavity, helps pull the magnet off the body, thus releasing the first lever from engagement with the second lever, to allow rotation of the now magnetically uncoupled body, to allow motion of the first lever-relative to the second lever, so the cavity now has a downward orientation.

Pulling the tension member can rotate the clutch body relative to the lifting point to allow the clutch to be lifted away from the lifting point and release the lifting point from the clutch body.

In some embodiments, the first lever pivots about a pivot point to pivot relative to the body between the engaged and disengaged positions.

In some embodiments, the tensioning member is attached to a distal end of the first lever.

In some embodiments, the pivot point is located towards a side of the body opposite to the cavity opening, so that the lifting point is received in the cavity between the pivot point and the opening.

In some embodiments, the pivot point is located below a central axis of the head of the lifting point.

In some embodiments, the pivot point between the first lever and the body is positioned at or adjacent a proximal end of the first lever.

In some embodiments, the first lever comprises an engagement surface to engage a proximal end of the second lever.

In some embodiments, the engagement surface is located on the first lever between a distal end and a proximal end of the first lever, or between the tensioning member attachment to the first lever and a pivot point of the first lever on the body.

In some embodiments, the first lever comprises a cam surface to contact the second lever so that pressing the first lever against the second lever towards the engaged position causes the second lever to move to the close position.

In some embodiments, in the close position a distal end of the second lever extends at least partially across the cavity of the body to at least partially block the cavity opening.

In some embodiments, the second lever pivots about a pivot point to pivot relative to the body between the close and open positions.

In some embodiments, the pivot point for the second lever is located between a distal end and a proximal end of the second lever, so that the first lever has a first lever arm extending between the pivot point and the proximal end and a second lever arm extending between the pivot point and the distal end.

In some embodiments, the second lever is configured so that with the clutch body rotated to position the cavity opening downwards, the second lever is biased to the open position by gravity.

In some embodiments, the second lever is configured so that with the body rotated to position the lifting eye above the cavity, the second lever is biased to the close position by gravity.

Preferably, the clutch as described above has a cavity which includes a primarily by J-shaped cross-sectional recess for receiving and locating the lifting point at the arcuate portion of the J-shape.

### Offset Aspect

According to a second aspect to the present invention there is provided a clutch for use with lifting equipment for lifting a load, the clutch comprising:
a body;
wherein the body has a cavity connected to an opening on the side of the body to receive a lifting point therein, wherein the first and second pivotable lever arrangement provide:
a closed configuration where the opening to the cavity is at least partially blocked by the second lever which is engaged with the first lever; and
an open configuration wherein the second lever moves to provide free access to the cavity via the opening when the first lever disengages the second lever; wherein the body includes an offset on the lower edge of the body on the opposite side of the body to the opening and cavity, the offset providing a ledge which can engage with the lifting point to prevent rotation in one direction of the lifting point relative to the clutch.

This second aspect is directed at overcoming a problem with bar clutches which secure bar lifting points and have unwanted rotation of the lifting point and the panel to which it is connected when the lifting apparatus moves the panel in a forward direction.

### Method Aspect

According to a third aspect there is provided a method of holding a load to be carried by a lifting apparatus utilising a hook for securing the load to be lifted comprising the steps of:
a) Providing a clutch to interface between a load to be lifted and the hook connecting to the lifting apparatus;
b) providing a magnet of known magnetic strength for operation of said clutch and to provide a known maximum lift weight for the load to be carried.

Magnets suitable for use with the present invention may include:
Neodymium magnets;
Non-neodymium rare earth magnets such as but not limited to samarium cobalt magnets.

In preferred embodiments, neodymium magnets may range from N35 to N55 in grade. Noting the higher the number the higher the magnetic force.

Preferably, to avoid corrosion of the magnet given the high iron content of the neodymium magnets mentioned above may be coated on the on the outer non-threadable surfaces with a moisture resistant layer.

Preferably, to avoid corrosion a samarium cobalt magnet may be utilised with the present invention.

Advantages (and hence objectives) of the present invention as described herein may include one or more of the following:
Less mechanical parts and therefore less manufacturing costs in terms of labour;
Less mechanical parts and therefore less chance of mechanical failure due to wear and tear;
Known limits of the maximum load can be carried and ability to easily change limits by replacement of magnet with higher or lower strength magnet;
Ability to have an electrical or physical remote control system.

According to a further aspect there is provided a lifting apparatus which includes a clutch substantially as described herein.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more preferred embodiments of the invention will be described below by way of example only, and without intending to be limiting, with reference to the following drawings, in which:

FIG. 1 is a side view of a clutch assembly for lifting a load with a crane or other lifting apparatus or machinery, with the clutch in a closed position set for lifting a load secured to a lifting point, according to one embodiment of the present invention;

FIG. 2 is a front view of the clutch assembly of FIG. 1 set for lifting a load;

FIG. 3 is a cross-sectional side view of the clutch assembly in FIGS. 1 and 2 showing the clutch in a closed (locked) position when the magnet is engaged;

FIG. 4 is a cross-sectional side view of the clutch assembly in FIG. 3 when the magnet is released;

FIG. 5 is a cross-sectional side view of the clutch assembly in FIG. 4 as the clutch body is rotated to release the bar portion of the lifting point.

FIG. 6 is a side view of the clutch body with the clutch in an open position set for receiving or releasing a lifting point;

FIG. 7 is a side view of a clutch assembly for lifting a load with a crane or other lifting apparatus or machinery, with the clutch in an open position set for lifting a load secured to a lifting point having a bar portion, according to a further embodiment of the present invention;

FIG. 8 is a cross-sectional side view of the clutch assembly of FIG. 7;

FIG. 9 is a side view of a clutch assembly for lifting a load with a crane or other lifting apparatus or machinery, with the clutch in an open position set for lifting a load secured to a lifting point having a ball portion, according to a further embodiment of the present invention;

FIG. 10 is a cross-sectional view of the clutch assembly in FIG. 9.

### BRIEF DESCRIPTION OF PREFERRED EMBODIMENTS OF THE INVENTION

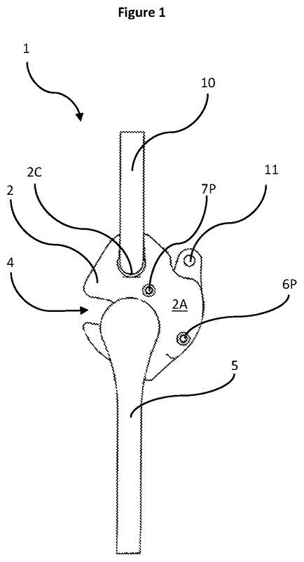

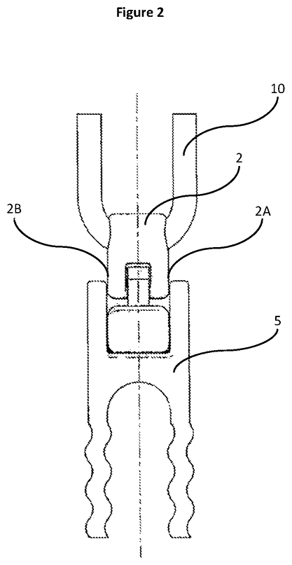

FIGS. 1-6 show a clutch 1 which has a body 2 with a cavity 3 therein and a side opening 4.

A bar type lifting point 5 can be received into the cavity 3 via opening 4 and held therein via a second lever 7. The lifting point 5 having a bar portion 5B which is retained by and held by the clutch.

The body 2 is formed to have an upper middle section 2UM and a lower middle section 2LM collectively forming the cavity 3 between outer walls 2A and 2B of the body 2.

The lower middle section 2LM is formed so as to create a substantially J-shaped recess for receiving and locating the lifting point at the arcuate portion of the J-shape.

The first and second pivotable lever arrangement comprises a first lever 6 and a second lever 7. The first and second levers 6 and 7 have apertures 6A and 7A which enable them to rotate around pin and bearing arrangements 6P and 7P relative to body 2.

The second lever 7 has an internally threaded aperture 8 which receives an externally threaded magnet 9.

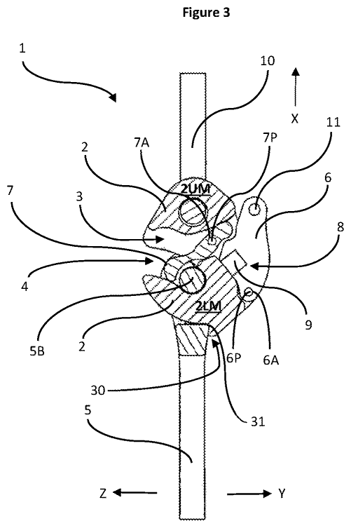

In use, when the clutch has the lever arrangement in the closed position as shown in FIGS. 1 and 3 the magnet 9 contacts and magnetically engages lower middle section 2LM of the body 2 (which is understandably constructed from a magnetic material preferably but not limited to SAE 4340 steel). This causes the second lever to engage and hold the first lever 6 in a position obstructing the opening 4 to the cavity 3 as shown in FIG. Y—to retain bar portion 5B of the lifting point 5 in the clutch 1.

It will be appreciated the lower middle section which engages with the magnet may be made from any magnetic metal or metal alloy which has a sufficient magnetic attraction to a magnet and is also a high strength material and suitable for use with cranes carrying heavy loads such as precast concrete panels.

The magnet 9 used in this embodiment is 10 mm in diameter and 10 mm long and has a pull strength of 15 pounds.

The body 2 also has an aperture 2C which receives in use a coupling in the form of a shackle 10 which is used connect the clutch 1 to a hook (not shown) associated with a lifting apparatus in the form of a crane (not shown).

The first lever 6 has an aperture 11 which receives a cable or the like (not shown) which is connected to a remotely operable winch arrangement (not shown).

The winch arrangement when activated pulls the first lever 6 in a substantially upward direction as indicated by arrow X.

This causes the first lever 6 and the body 2 to move upwardly until the magnetic force is overcome by the weight being lifted by the clutch and the first lever pivots on the pin and bearing arrangement 6P.

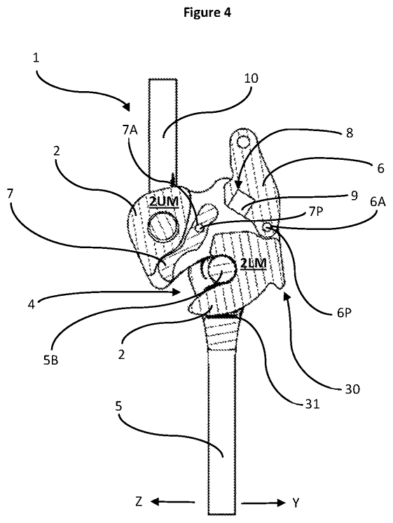

This in turns causes the first lever 6 to disengage with the second lever 7 as shown in FIG. 4 which rotates on pin and bearing arrangement 7P to provide free access to and from cavity 3.

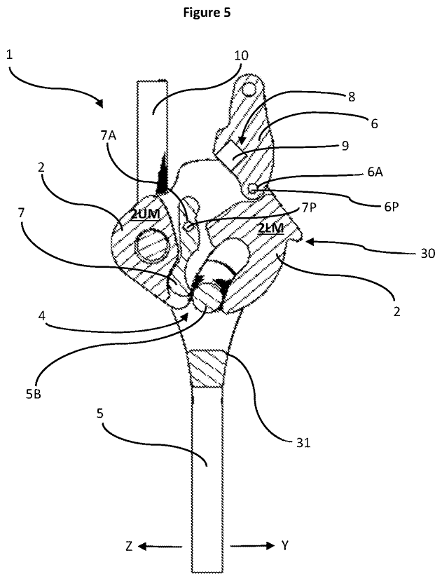

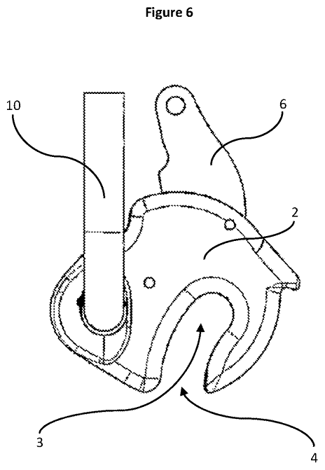

Further pulling on the lever 6 by the winch cable in direction X causes the clutch body and cavity to move from a substantially lateral orientation to a substantially downward orientation as can be seen in FIG. 5.

The clutch can then be lifted away from the bar 5B of the lifting point 5 as shown in FIG. 6.

The clutch as shown in FIG. 6 is also showing what the clutch would look like when it is ready to be attached to a lifting point. The clutch by is moved manually by a person so the cavity captures the bar and then the user manually rotates the clutch body clockwise. This rotation causes the first lever 6 to rotate in an anti-clockwise direction which can be seen when one looks sequentially at FIGS. 5 and 4. This rotation of the clutch body causes the magnet 9 to engage (magnetically couple) with the lower middle section 2LM of the body 2.

In relation to FIG. 3 there is also shown an offset 30 on the lower middle section 2LM of the body 2 which forms a ledge 31 which overlaps a portion of, and contacts, an outside face of the lifting point 5F.

As can be seen ledge 31 prevents free rotation of the lifting point and associated load (not shown) such as a concrete panel in the direction shown by arrow Y as the lifting apparatus (not shown) moves the panel forward in direction Z.

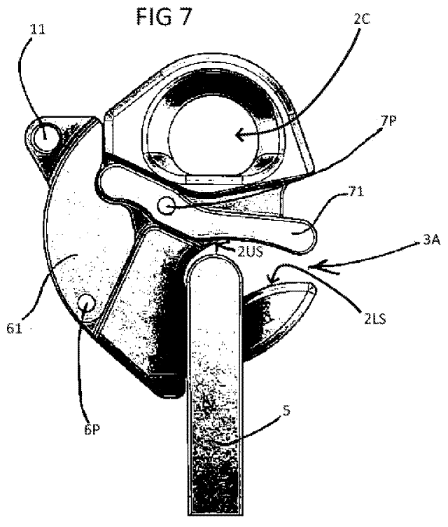

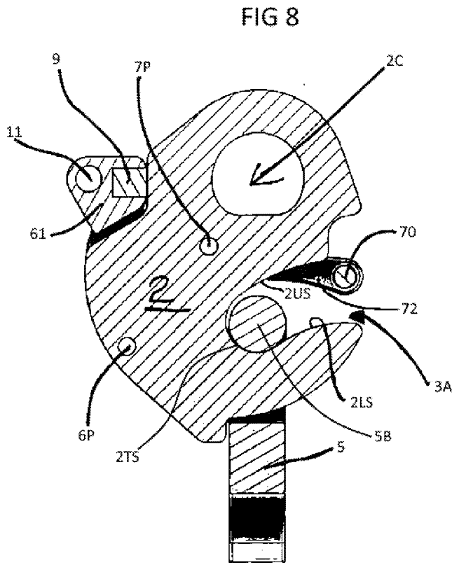

In relation to FIGS. 7 and 8 there is shown a clutch assembly according to a further embodiment to those in the previous Figures. Like elements in FIGS. 7 and 8 to those in the previous figures have been given like reference numerals. The key differences of this embodiment to those in the previous figures are now detailed.

In FIGS. 7 and 8 one of the key differences is that there is now a pair of first levers 61 and 62 on either side of the clutch when looked at front on/end on (of which only one is shown in each of FIGS. 7 and 8).

There is also pair of second pair of levers (second lever pair) 71, 72, again located externally on either side of the body 2. The second lever pair 71 and 72 are connected to one another, at their respective distal ends via a pin 70. The pin 70 restricts the opening of the cavity 3A to hold the lifting point 94 therein.

The first and second lever pairs interact with one another in the same manner as that previously described in relation to FIGS. 1-6 above.

Another key difference is the cavity 3A no longer has an upper middle section 2UM and a lower middle section 2LM collectively forming the cavity 3. By way of contrast, the cavity 3A is formed to have an upper surface 2US and a lower surface 2LS which are connected to one another via terminal surface 2TS.

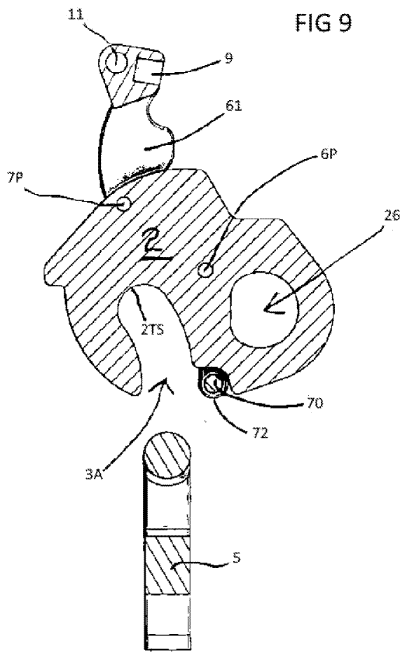

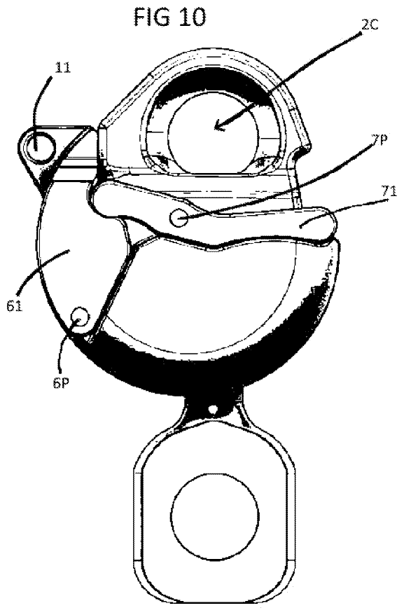

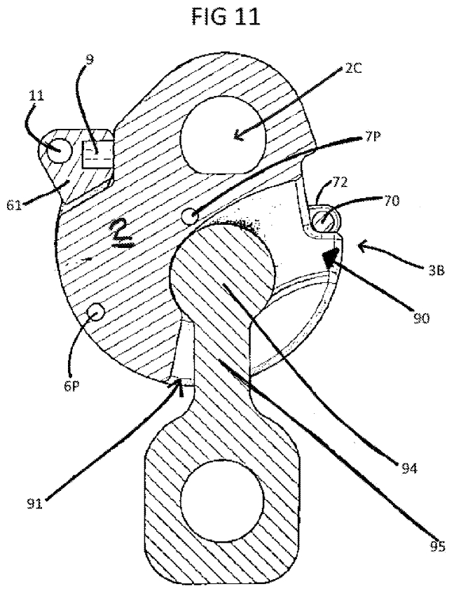

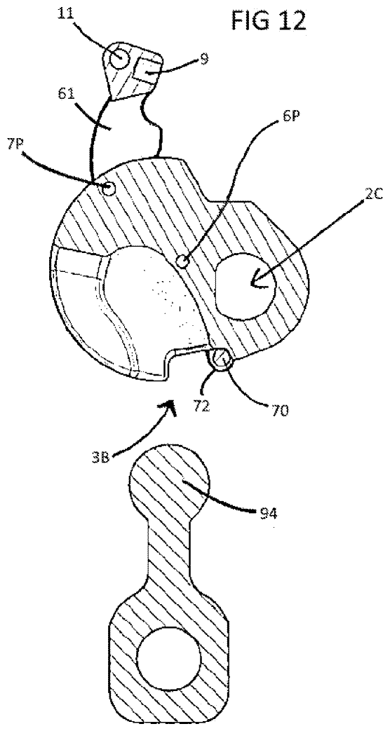

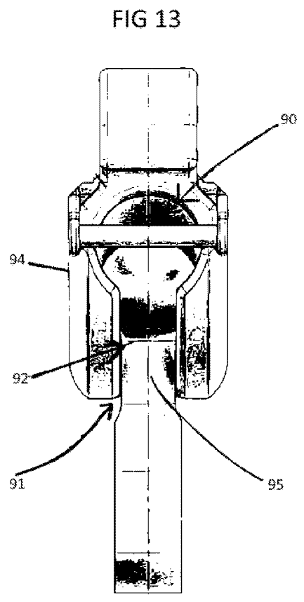

In relation to FIGS. 9 and 10 there is shown a clutch assembly according to a further embodiment to those in previous FIGS. 1-8. Like elements in FIGS. 9 and 10 to those in the previous figures have been given like reference numerals. The key differences of this embodiment to those in the previous FIGS. 1-6 are now detailed.

In FIGS. 9, 10 and 11 one of the key differences is that there is now a pair of first levers (first lever pair) 61 and 62 (of which only one is shown). There is also a second lever pair 71, 72, which are respectively located externally on either side of the body 2. The second lever pair 71 and 72 are connected to one another, at their respective distal ends via a pin 70.

The second lever pair 71, 72 are also located externally on either side of the body 2. The first and second lever pairs interact with one another in the same manner as that previously described in relation to FIGS. 1-6 above.

The embodiment of FIGS. 9, 10 and 11 also has a different cavity 3B to that shown in the earlier FIGS. 1-8.

Notably, the cavity 3B has a mouth portion 90 connected to a throat portion 91 the throat portion having a further slotted opening 92. In use the ball portion 94 of the lifting point enters the mouth portion 90 which leads into the throat portion 91, and then when the clutch body 2 is rotated to close the clutch the neck 95 of the ball portion becomes located in the throat portion 91 of the cavity 3B.

1-17. (canceled)

18. A clutch for use with lifting equipment for lifting a load, the clutch comprising:
a body;
wherein the body has a cavity connected to an opening on the side of the body to receive a lifting point therein, wherein located within said cavity is a first and second pivotable lever arrangement, comprising a first lever or pair of connected levers and a second lever or pair of connected levers, wherein the pivotable lever arrangement provides:
a closed position where the opening to the cavity is at least partially blocked by the second lever/second lever pair which is engaged with the first lever/first lever pair; and
an open position wherein the second lever/lever pair moves to provide free access to the cavity via the opening when the first lever/lever pair disengages the second lever/lever pair;
wherein the first or second lever/lever pair is held in engagement with the respective first or second lever/lever pair to maintain a closed position, via a magnet attached to said first or second lever/lever pair to magnetically couple said first or second lever/lever pair to said body, so the cavity maintains a laterally and upwardly inclined orientation.

19. The clutch as claimed in claim 18, wherein the first lever pivots about a pivot point to pivot relative to the body between the engaged and disengaged positions.

20. The clutch as claimed in claim 19, wherein the tensioning member is attached to a distal end of the first lever.

21. The clutch as claimed in claim 19, wherein the pivot point between the first lever and the body is positioned at or adjacent a proximal end of the first lever.

22. The clutch as claimed in claim 19, wherein the pivot point is located towards a side of the body opposite to the cavity opening, so that the lifting point is received in the cavity between the pivot point and the opening.

23. The clutch as claimed in claim 19, wherein the pivot point is located below a central axis of the head of the lifting point.

24. The clutch as claimed in claim 18, wherein the first lever comprises an engagement surface to engage a proximal end of the second lever.

25. The clutch as claimed in claim 24, wherein the engagement surface is located on the first lever between a distal end and a proximal end of the first lever, or between the tensioning member attachment to the first lever and a pivot point of the first lever on the body.

26. The clutch as claimed in claim 18, wherein the first lever comprises a cam surface to contact the second lever so that pressing the first lever against the second lever towards the engaged position causes the second lever to move to the close position.

27. The clutch as claimed in claim 18, wherein in the close position a distal end of the second lever extends at least partially across the cavity of the body to at least partially block the cavity opening.

28. The clutch as claimed in claim 18, wherein the second lever pivots about a pivot point to pivot relative to the body between the close and open positions.

29. The clutch as claimed in claim 28, wherein the pivot point for the second lever is located between a distal end and a proximal end of the second lever, so that the first lever has a first lever arm extending between the pivot point and the proximal end and a second lever arm extending between the pivot point and the distal end.

30. The clutch as claimed in claim 18, wherein the second lever is configured so that with the clutch body rotated to position the cavity opening downwards, the second lever is biased to the open position by gravity.

31. The clutch as claimed in claim 18, wherein the second lever is configured so that with the body rotated to position the lifting eye above the cavity, the second lever is biased to the close position by gravity.

32. The clutch of claim 18 wherein the body includes an offset on the lower edge of the body on the opposite side of the body to the opening and cavity, the offset providing a ledge which can engage with the lifting point to prevent rotation in one direction of the lifting point relative to the clutch.

33. A lifting apparatus which includes a clutch as claimed in claim 18.
